(19) United States
(12) Patent Application Publication
(10) Pub. No.: US 2015/0046076 A1
(43) Pub. Date: Feb. 12, 2015

(54) Navigation system for vehicles

(71) Applicant: Vicinity Software Limited, Dublin (IE)

(72) Inventor: Con William Costello, Dublin (IE)

(73) Assignee: VICINITY SOFTWARE LIMITED, Dublin (IE)

(21) Appl. No.: 14/449,412

(22) Filed: Aug. 1, 2014

(30) Foreign Application Priority Data
Aug. 9, 2013 (IE) 2013/2038

(51) Int. Cl. G01C 21/34; G01C 21/36

(52) U.S. Cl. CPC G01C 21/3469; G01C 21/36
USPC 701/118; 701/400; 701/117; 701/538; 701/29.1

(57) ABSTRACT

The present invention relates to vehicles, specifically to an improved navigation system. In order to provide a technology, which will permit drivers of vehicles to better predict consumption and to conserve energy, for example energy in the form of electric battery power or fuel, and to extend the vehicle's driving range, a method for optimizing a driving range of a vehicle, the method typically comprising the following steps: a) predicting driving routes based on a determined start and target route points based on a stored road network model; b) providing additional situation related data comprising environmental factors; c) calculating energy consumption of energy stored on board the vehicle for the predicted driving routes based on the situation related data; and d) determining a most economical route with regards to a minimized energy consumption.

### FIELD OF INVENTION

The present invention relates to vehicles, and relates specifically to a method for optimizing a driving range of a vehicle, to a driving range optimizer for a vehicle, to a vehicle, and to a use of a driving range optimizer in a passenger car, as well as to a computer program element and a computer readable medium.

### BACKGROUND

For many decades the internal combustion engine has offered an affordable and reliable mode of transportation. In recent years however, environmental concerns and reduced availability of affordable crude oil have driven a need for reduced fuel consumption.

Vehicle manufacturers increasingly market low-consumption gasoline vehicles, hybrid electric and fully electric vehicles—though it is now widely accepted that fully electric vehicles represent the future. Electric vehicles are considered to be substantially more efficient than those powered by gasoline.

The principal barrier to mass adoption of electric vehicles is driving range—typical driving range limits are less that 150 km per charge. Moreover, available range may vary, for example, caused by individual driving habit or environment, potentially resulting in ‘range anxiety’ for the motorist.

The industry is seeking to increase the driving range of electric vehicles and to reduce range anxiety. In a broader context, motoring economy is also a matter for combustion vehicles and a demand exists for technologies which permit combustion vehicles to conserve fuel.

### SUMMARY OF THE INVENTION

A need may therefore exist for a technology, which will permit drivers of vehicles to better predict driving range and to conserve energy, for example energy in form of electric battery power or fuel, and extend the vehicle's driving range.

The object of the present invention is solved by the subject matter of the independent claims.

Further embodiments are incorporated in the dependent claims. The following described aspects of the invention apply also for the method for optimizing a driving range of a vehicle, the driving range optimizer, the vehicle, and the use of a driving range optimizer in a passenger car.

According to the invention, a method for optimizing a driving range of a vehicle provided that, the method comprising the following steps:
a) predicting driving routes based on a determined start and target route points based on a stored road network model;
b) providing additional situation related data comprising environmental factors; and
c) calculating energy consumption of energy stored on board the vehicle for the predicted driving routes based on the situation related data; and
d) determining a most economical route with regards to a minimized energy consumption.

This is in particular suitable for electric vehicles, but it may also be used in combustion vehicles. The invention herein relates to a navigation system which enables drivers of all vehicle types to find the ‘most efficient’ route to their destination, and in other embodiments, to better predict available driving range or to access other relevant information pertaining to their journey. As an advantage, the driver may better understand the available range within the driving context.

According to the invention, a driving range optimizer for a vehicle is provided that comprises at least one of the group of: at least one processor; at least one storage unit; a data interface; and a user interface. The at least one processor is configured to predict driving routes based on determined start and target route points based on a stored road network model; and to calculate energy consumption of energy stored on board the vehicle for the predicted driving routes based on the situation related data; and to determine a most economical route with regards to a minimized energy consumption. The at least one data interface is configured to provide additional situation related data comprising environmental factors. The user interface is configured to provide the most economical route.

The invention is directed towards an improved process for predictive vehicle routing, specifically a method by which a user may determine the most economical route between two or more points, or the consumption associated with a particular journey.

The invention provides a navigation system, which will provide motorists with a prediction of the most economical driving route to their destination, and/or the potential consumption associated with each potential route, and/or any auxiliary information relevant to their journey. In an example, step c is not performed as potential consumption is not always determined.

Accordingly, in an example, there is provided a processor as prediction server, and a database of prediction variables. For creating route predictions according to said variables, the processor is so configured to:
communicate with internal and external systems;
receive route requests of many types in a plurality of formats;
describe the shortest, fastest, most power- (or fuel-) efficient route, or other route;
describe the potential power- (or fuel-) consumption associated with each route;
describe the potential variance in available range associated with each route;
describe geographic, commercial, social, environmental or other features en route;
consider a plurality of variables, in real time or historic form, comprising at least one of the group of: historic consumption profile, traffic congestion, route geometry and typical speed, number of route stops and junctions, route gradient, wind direction and force, ambient light, time, date, location, precipitation, temperature, sunshine, humidity, dewpoint or fog, and on-board diagnostic data (OBD) from the vehicle engine control unit (ECU);
deliver route responses of many types in a plurality of formats; and
render, store, reuse or purge data, or execute computer code.

In one embodiment, the processor is adapted to:
gather and process input data from a plurality of sources;
maintain a spatial database pertaining to the road network.

In a further embodiment, each segment of the route network has a plurality of attributes describing each of the variables which impact consumption, or are otherwise of interest.

In one embodiment, the processor is adapted to:
consider the requested origin, destination and any waypoint locations;
compute journey routes subject to preferred criteria;
prepare directions, summaries, tables, graphics, statistics, charts or maps; and to
deliver the requested output across a plurality of formats and media.

In one embodiment, the processor is adapted to initially create a candidate set of routes for presentation to the user, ordered by for example; economy, speed, distance, type of environment, tourism interest, security or previous preference.

In one embodiment, the processor is adapted to communicate with the vehicle ECU with a view to receiving OBD data, including data upon the current state of charge, available fuel, rate of consumption or state of on-board components.

In one embodiment, the processor is adapted to augment the range prediction provided by the vehicle ECU and to deliver an improved range prediction.

In another embodiment the processor is adapted to communicate with the vehicle in order to receive origin, destination or waypoint instructions, or other journey preferences, via the on-board vehicle SatNav or a similar interface.

In one embodiment the processor is adapted to communicate with the vehicle ECU in order to deliver prediction results to the on-board vehicle SatNav or a similar graphical or audio interface.

In a further embodiment, the processor is adapted to communicate with connected devices, including mobile handheld devices or on-board information systems, enabling such devices to request or generate route predictions.

In one embodiment, the processor is adapted to be located in a computer server, or in the cloud, and to be accessed remotely. This is typically known as a primary processor.

In another embodiment, the processor is adapted to be on-board a vehicle or otherwise mobile. This is typically known as a secondary processor.

In a further embodiment, the processor is adapted to operate independently, and reside solely on one device.

In one embodiment, the processor is adapted to record power consumption experienced by vehicles on individual route segments. Such records may be either numerical, graphical or descriptive in nature.

In one embodiment, the processor is adapted to identify previously preferred routes and to present these to the user as part of a candidate set of recommended routes.

In one embodiment, the processor is adapted to monitor the position of the vehicle and to periodically re-compute the route using the latest variables.

In one embodiment, the prediction variables may be drawn from static data, while in another they may be drawn from forecast data, or from sensor acquired data.

In a further embodiment, the function of the processor may be adapted to accommodate individual vehicles, vehicle types, vehicle styles, geographies, fuel types or user driving styles.

In another embodiment, the processor may deliver supplementary information relating to the journey, such as regional pollen count, crime or other safety related data, road traffic accident information, land-cover descriptions, recharge point availability, tourist information; or any other information relevant to the vehicle occupant.

In another embodiment, the processor may be configured to deliver journey information in the form of a narrative, describing potential routes from beginning to end, for example; the length of journey, weather which will be encountered, type of roadway or geography which will be traversed, points of interest en route, recommended fuelling or break stops, flora and fauna, or other relevant sights to look out for en route. Such narratives may be delivered as text, graphically (in the form of an EcoGram), or audibly, and may be customised by the user, or preferences automatically learned by the system.

In another embodiment, the processor is adapted to apply a routing algorithm to eliminate errors and exclude possible manoeuvres.

In another aspect, the invention provides a computer storage medium comprising software code for performing operations of any system defined above when executing on a digital processor.

According to the invention, there is provided a navigation system comprising at least one prediction server (or “processor”). The processor is central to the invention and handles computations and route related requests from connected devices. Typically based in the cloud, the processor also stores, manages and renders attribute data relevant to route computations.

In another embodiment a “secondary prediction server” (or “secondary processor”) exists. A secondary processor typically resides on-board the vehicle, or a mobile digital device, and partially fulfils the role of the processor should a communications channel be unavailable. Advantageously, the secondary processor is capable of acting independently or in tandem with the processor. In one embodiment, non-perishable data may be stored and processed on the secondary processor, whilst perishable data may be drawn from the processor in a smart client or similar architecture.

The processor contains three main parts. First, the road network model, which describes the road network in geographical and logical terms. Second, attribute data relating to each road segment known as the “Prediction Variable” data. Finally, software code capable of interpreting requests, performing route predictions and communicating output to the various devices and services.

A great number of variables are known to impact the power (or fuel) consumption of a vehicle. These include, but are not limited to a first group, known as ‘universal variables’:
Factors relating to the state of the battery: state of charge, capacity, size, type, age, cycle, temperature, air pressure, regenerative braking input.
Factors arising through normal vehicle operation: Drive mode (eco), driving style (braking/acceleration), electrical draw from the infotainment system, GNSS system, micro processors and other electrical and electronic systems.
Factors arising through dynamic resistance: Body style (aerodynamics), tyre type/age/inflation, roof rack (on/off), window state (open/closed), power train (quality/age), wheel size/camber/tracking, road surface (friction).
Factors arising from inertia: vehicle, passenger, fuel, luggage and trailer mass.

The aforementioned “universal variables” may be considered to be relatively consistent across all routes and therefore have little bearing on which route is taken. In terms of range prediction, the effect of these variables is accommodated within the existing range prediction on the dashboard.

Then exists a second group of variables, which impact power (or fuel) consumption. Also referred to as the “Prediction Variables”, these variables sometimes vary substantially across different routes. Their effect varies with environment and is therefore not reflected within the existing range prediction on the dashboard.
Factors arising through use of peripheral electrical devices within the vehicle: Interior fan/heater (temp./demist), Interior air-conditioning (temp. control), Window wipers (rain), Vehicle lighting (headlamp, indicator, fog, brake).
Factors arising through external environmental effects: Wind force/direction, Route geometry (braking/acceleration), Number of junctions (start/stops), Road gradient (climb/fall), Traffic congestion (start/stops/reduced headwind).

It is these prediction variables, amongst others, which the invention uses to compare routes in terms of consumption. Similarly, in combination with vehicle data, these variables are used in the determination of the consumption required by each route and the remaining driving range available. It should be noted that in some embodiments, only a sub-set of the variables may be required, and that variables may be employed in any order or sequence, or not at all.

Through a conflation of data sources, each variable is individually retrieved, forecast, sensed, or otherwise computed for each potential journey route. The cumulative effect of the variables is attributed to each route segment and considered within preparation of a set of candidate routes to be offered to the user.

In an example, each individual variable is precisely retrieved, modelled, forecast or sensed:

The use of the electric ventilation fan, heater, air-conditioning is governed by the temperature within the vehicle. Through comparing the anticipated vehicle location and elevation with weather and humidity forecasts, the processor computes the percentage of the journey where these devices are likely to be used. Where available, the processor may also retrieve temperature data directly from sensors onboard the vehicle.

In an example, the invention considers the impact of route gradient upon consumption. Though the application of gradient as a road network model attribute, the system examines each potential driving route in terms of climb and fall. This permits not only the determination of the effect of climb upon consumption but also, in the case of electric vehicles, the charge available through regenerative braking.

In an example, the invention also considers the effect of head & tail wind upon consumption. The invention employs real-time wind measurements or forecasts, in combination with wind models, to determine the consumptive effect of headwind/tailwind on each route. Through employment of computational fluid dynamics, digital elevation models and land-cover data; local wind force is universally computed and attributed to the road network route model.

Route geometry impacts driving style, and therefore consumption. The invention employs a road network model in order to identify portions of road where braking or acceleration will consume power, for example near bends and junctions. Similarly, the processor considers electrical consumption resulting from such manoeuvres, in terms of the potential use of indicator and brake lights, per route.

Candidate routes are also compared in terms of the impact of traffic congestion. A traffic data forecast is applied to each potential route in terms of potential braking and acceleration required and the impact of this behaviour on consumption, and in a further embodiment the recording of this behaviour as the style typical of the individual user.

For example, the invention considers the consumptive impact of vehicle lighting. Through consideration of geographic location, local lighting-up time is calculated per route and the percentage of journey to be undertaken with lighting is attributed to the consumption forecast. Similar checks are performed to identify when cloud cover, fog, or law may demand the use of lighting.

The invention predicts the portion of the journey when precipitation will demand the use of windscreen wipers. Precipitation radar and similar sensors are used to identify when rain is tracking towards a potential route. Precipitation data is typically simplified as raster or vector graphics and, though estimation of extent, bearing and speed individual road network segments are attributed with a precipitation forecast. In a related embodiment, vehicle mounted precipitation sensors may inform the processor, strengthening the overall prediction.

The invention delivers prediction results in a number of styles and across various media. In one embodiment results are delivered in a revolutionary new graphical form known as an ‘Ecogram’ which describes each potential route in a narrative form, providing the user with a detailed understanding of the journey ahead. The ecogram provides the user with an easily interpreted, language neutral and easily customised method to display journey variables.

In an example, based on the determined most economical route, an adapted performance profile for controlling an engine's power output for driving the vehicle is generated and provided for further travelling.

These and other aspects of the present invention will become apparent from and be elucidated with reference to the embodiments described hereinafter.

### BRIEF DESCRIPTIONS OF THE DRAWINGS

The invention may be more clearly understood from the following description of a preferred embodiment, which is given by way of example only with reference to the accompanying drawings, and in which:

FIG. 1 is a representation of the parts of the invention;

FIGS. 2 and 3 are maps illustrating aspects of the invention; and

FIGS. 4 and 5 are examples of Ecogram layouts.

### DETAILED DESCRIPTIONS OF EXEMPLARY EMBODIMENTS

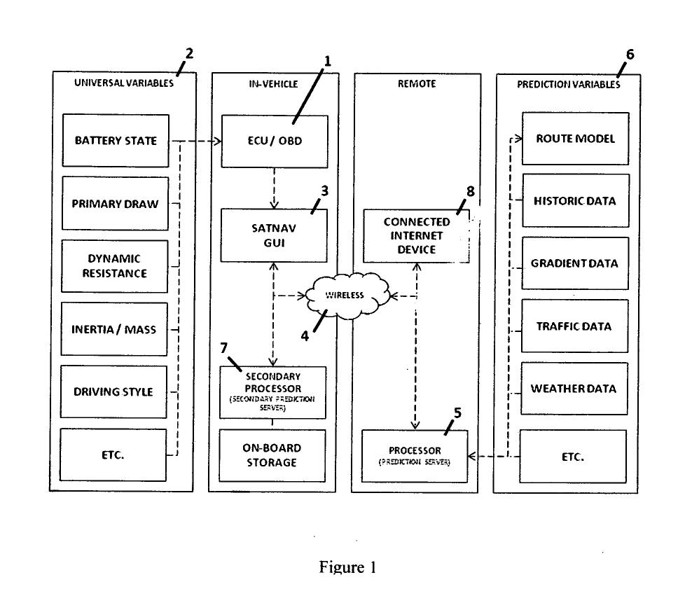

FIG. 1 shows a schematic layout of the invention with different data flow and data connections. A vehicle (not further shown) comprises an ECU 1, which processes data pertaining to vehicle function. The ECU holds data regarding the current state of battery charge and recent rates of consumption, factors, which are largely governed by universal variables 2. On-board SatNav 3, or a similar interface, displays relevant information and permits the user to input desired destination preferences.

Where the vehicle is internet-connected wirelessly 4, the user may request a prediction of a processor 5 as to which route will be most economical. Using the road network model, software code, and navigation attributes derived from prediction variables 6, the processor will compare each route in terms of potential consumption. The prediction will be conveyed to the user, who may select a route from a candidate set.

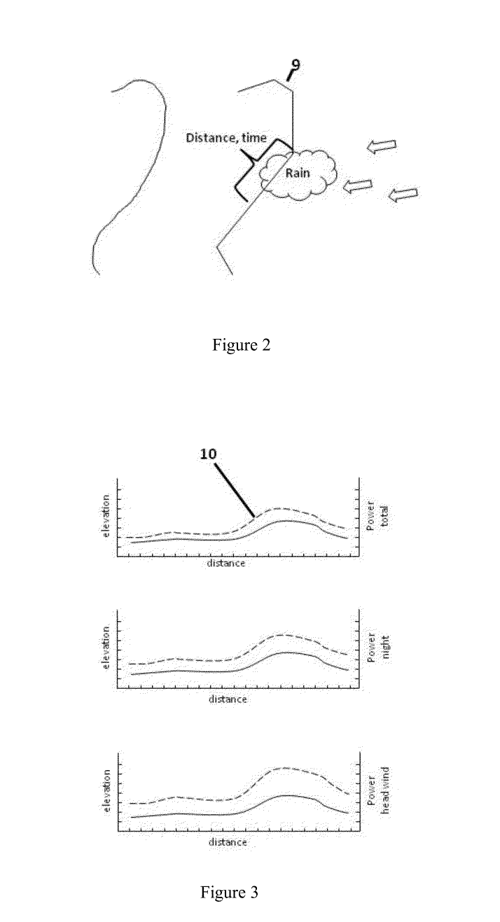

The prediction variables 6 employed in each case may vary depending upon availability, local environment and vehicle type, only some attributes may be required. Each variable is typically processed independently, with results combined to produce the navigation attributes. By way of example, FIG. 2 illustrates how weather forecast data may be spatially attributed to a simplified road network 9, wherein a forecast of wind force or direction may be employed, and/or where precipitation radar data may be consumed to attribute the road network model 9.

In performing a route prediction, the processor not only relies upon theoretical computations. Empirical measurements relating to individual road segments are recorded for all relevant vehicle scenarios. Such measurements are stored in a unique semi-graphical format known as a ‘consumption fingerprint’, as illustrated in FIG. 3. wherein the effect of individual prediction variables, or other consumption data, may be recorded graphically.

Wherein the vehicle is not wirelessly internet-connected, a secondary processor 7 on-board the vehicle may provide a limited prediction using cached prediction variables. This secondary processor may operate independently, within a smart client architecture or in conjunction with the main processor 5.

Predictions may also be performed through any remote internet-connected device 8, wherein the user may request a prediction as to which route between two or more locations will be most economical. Where the vehicle ECU 1 is in communication with the processor 5, and the user has been suitably authorised, a full prediction will be returned. Where the vehicle ECU 1 is not connected to the processor a generic comparison of routes may be performed, or where historical data pertaining to the user or vehicle or driving style is available, a partially augmented computation will be returned.

The process described is not exhaustive in nature and may be modified to accommodate differing fuel types, vehicle styles, and information or communication architectures.

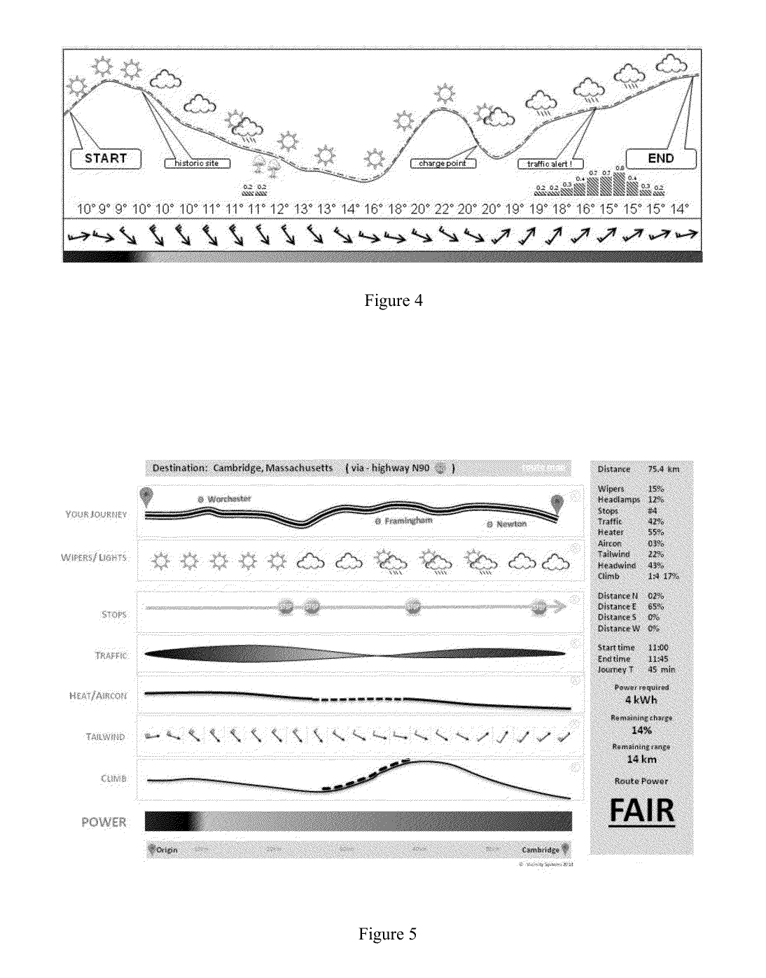

FIGS. 4 and 5 provide potential representations of ecogram layouts, though it must be understood that journey data may be represented in many similar graphical forms. FIG. 4 depicts the journey narrative in a compact style, illustrating an individual route from beginning to end and the various factors which are forecast to be encountered en route, wherein, from top to bottom, said illustration depicts the following variables; weather forecast in the form of cloud or sunshine figures; route slope as a longitudinal section; points-of-interest as text callout bubbles; precipitation in the form of a histogram; forecast temperature as a series of numeric figures; wind force and direction as arrows; and power (or fuel) consumption as a shaded band. FIG. 5 provides a similar illustration, depicting how each factor may be shown individually, or potentially how the ecogram interface may be customised to user preference wherein, from top to bottom, said illustration depicts the following; a top view of the route to be travelled; weather forecast in the form of cloud or sunshine figures; the number of stops along the route as stop sign figures; traffic congestion as a shaded line graphic depicting both volume and flow; predicted journey temperature and use of air conditioning, heater or fan as a simple line graphic; wind force and direction as arrows; route slope as a longitudinal section; power (or fuel) consumption as a shaded band; and various numeric tabulations which provide additional data for the benefit of the user.

It must be noted that the embodiments of the present invention are described with reference to different subject matters; some embodiments are described with reference to method type claims whereas other embodiments are described with reference to device type claims. A person skilled in the art will gather that, unless otherwise notified, in addition to any combination of features belonging to one type of subject matter, also any combination between features relating to different subject matters is considered to be shown with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for optimizing a driving range of a vehicle, the method comprising the following steps:
a) predicting driving routes based on a determined start and target route points based on a stored road network model;
b) providing additional situation related data comprising environmental factors; and
c) determining a most economical route with regards to a minimized energy consumption.

2. Method according to claim 1, wherein the additional situation related data comprises at least one of the group of:
environmental factors comprising metrology data, wind forecast, temperature, rain and snow fall;
precipitation forecast in prediction of use of vehicle functions; and
traffic related prediction.

3. Method according to claim 1 or 2, wherein the system considers the activation and use of at least one of the group of:
windscreen wipers in relation to weather forecast;
vehicle lighting in relation to daylight prediction; and
vehicle heating in relation to temperature forecast; and
wherein the system predicts the power consumption of on-board electrical devices in determination of the most economical route.

4. Method according to one of the preceding claims, wherein the system considers at least one of the group of:
i) driving style profiles;
ii) route gradient; and
iii) road geometry.
in determination of the most economical route

5. Method according to one of the preceding claims, wherein the system comprises a process for graphically recording geo-referenced consumption profiles.

6. Method according to one of the preceding claims, wherein the system predicts available driving range.

7. Method according to one of the preceding claims, wherein land-cover data is used.

8. Method according to one of the preceding claims, wherein, based on the determined most economical route, an adapted performance profile for controlling an engine's power output for driving the vehicle is generated and provided for further travelling.

9. Method according to claim 1, comprising the step of calculating energy consumption of energy stored on board the vehicle for the predicted driving routes based on the situation related data.

10. A driving range optimizer for a vehicle, comprising:
at least one processor;
at least one storage unit;
a data interface; and
a user interface;
wherein the at least one processor is configured to predict driving routes based on determined start and target route points based on a stored road network model; and to determine a most economical route with regards to a minimized energy consumption;
wherein a road network model is stored on the at least one storage unit;
wherein the at least one data interface is configured to provide additional situation related data comprising environmental factors; and
wherein the user interface is configured to provide the most economical route.

11. Driving range optimizer according to claim 10, wherein the processor is configured to generate a graphical narrative of the predicted environment, which will be traversed; and
wherein the user interface comprises a graphical display configured to show the graphical narrative.

12. Driving range optimizer according to claim 10 or 11, wherein it is further provided:
a processor as prediction server; and
a database of prediction variables;
wherein the second processor and the database are remotely located from a vehicle and are wirelessly connectable with the vehicle at least temporarily;
wherein, for creating route predictions according to said variables, the processor is so configured to:
communicate with internal and external systems;
receive route requests of many types in a plurality of formats;
describe the shortest, fastest, most power- (or fuel-) efficient route, or other route;
describe the potential power- (or fuel-) consumption associated with each route;
describe the potential variance in available range associated with each route;
describe geographic, commercial, social, environmental or other features en route;
consider a plurality of variables, in real time or historic form, comprising at least one of the group of: historic consumption profile, traffic congestion, route geometry and typical speed, number of route stops and junctions, route gradient, wind direction and force, ambient light, time, date, location, precipitation, temperature, sunshine, humidity, dewpoint or fog, and on-board diagnostic data from the vehicle engine control unit;
deliver route responses of many types in a plurality of formats; and
render, store, reuse or purge data, or execute computer code.

13. A vehicle with a driving arrangement with a motor and motor driven wheels, the vehicle comprising;
an on-board energy storage with a storage level; and
a driving range optimizer according to one of the claim 10, 11 or 12;
wherein the driving range optimizer provides a driving route for an optimized driving range considering the storage level of the on-board energy storage.

14. Use of a driving range optimizer according to one of the claim 10, 11 or 12 in a passenger car.

15. A computer program element for controlling a device according to one of the claims 10 to 13, which, when being executed by a processor, is configured to perform the method steps of one of the claims 1 to 8.

16. Computer readable medium, comprising stored the computer program element of claim 15.
